(19) United States
(12) Patent Application Publication
(10) Pub. No.: US 2018/0185879 A1
(43) Pub. Date: Jul. 5, 2018

(54) TROMMEL SCREEN CLAMPING APPARATUS

(71) Applicant: Aqseptence Group, Inc., New Brighton, MN (US)

(72) Inventors: Cristian Ignacio TORRES JARA, Region Metropolitana (CL); Dirk Holger NEUPER, Reckenroth (DE); Daryn BERTELSEN, New Brighton, MN (US)

(73) Assignee: Aqseptence Group, Inc., New Brighton, MN (US)

(21) Appl. No.: 15/740,661

(22) PCT Filed: Jun. 30, 2016
(86) PCT No.: PCT/US2016/040475

§ 371 Date: Dec. 28, 2017

Related U.S. Application Data
(60) Provisional application No. 62/187,127, filed on Jun. 30, 2015.

(51) Int. Cl. B07B 1/18; B07B 1/22; B07B 1/46

(52) U.S. Cl. CPC B07B 1/185; B07B 1/22; B07B 1/14; B07B 1/4618; B07B 1/4645

(57) ABSTRACT

A rotating clamp assembly and related methods of use for coupling one or more filter screens to a trommel frame. The rotating clamp assembly includes a pair of roller members that rotate relative to the trommel frame. The rotating clamp assembly can be coupled to the trommel frame by attaching a pair of clamp support members to an axial frame member. Each of the clamp support members and the roller members can comprise a central bore for slidably receiving a roller axle such that the roller members are rotatable relative to the clamp support members and the axial frame. Each roller member can rotatably interact with the axial frame member or alternatively, to the corresponding clamp support member to retain the filter screen. Each roller member can include a fastener that can be tightened to retain filter screen to the axial frame member.

### RELATED APPLICATION

The present application claims priority to U.S. Provisional Patent Application Ser. No. 62/187,127, filed Jun. 30, 2015 and entitled “TROMMEL SCREEN CLAMPING APPARATUS”, which is hereby incorporated by reference in its entirety.

### FIELD OF THE INVENTION

The present application is directed to a trammel screen apparatus and related methods of assembly. More specifically, the present application is directed to a rotatable screen clamp assembly for coupling filter panel assemblies to a trammel frame.

### BACKGROUND OF THE INVENTION

A trommel or rotary screen is a well known device for physically separating material of differing sizes. Generally, the trommel includes a drum-style frame including a one or more filter screens mounted to the walls of the drum-style frame. The drum-style frame can be rotated about a central axis whereby smaller particles pass through the filter screens and can fall below the trammel while larger particles are retained within the trommel. In some versions, these larger particles are removed from one end of the trommel while new material to be separated is introduced at an opposite end.

Generally, the one or more filter screens are attached to the drum-style frame using conventional fasteners, such as, nuts and bolts. Attachment and removal of these filter screens can be a laborious and time consuming process, especially when the trammel comprises a plurality of individual filter screens that are each, separately coupled to the drum-style frame. As such, it would be advantageous to improve upon conventional trammel design such that individual filter screens can be quickly attached, removed and replaced during assembly and/or maintenance.

### SUMMARY OF THE INVENTION

Embodiments of the present invention address the need to quickly attach and remove filter screens from trommel frames through the use of a rotating clamp assembly that is rotatably mounted to the trommel frame. The rotating clamp assembly can comprise a pair of roller members that rotate relative to the trommel frame for capturing the filter screen relative to the trommel frame. In some embodiments, the rotating clamp assembly can be coupled to an axial frame member on the trommel frame, for instance, by attaching a pair of clamp support members to the axial frame member. Each of the clamp support members and the roller members can comprise a central bore for slidably receiving a roller axle such that the roller members are allowed to rotate relative the clamp support members and the axial frame. In some embodiments, each roller member operates in an opposed direction for capturing adjacent filter screens that are located on opposed sides of the axial frame member. In some embodiments, each roller member can include one or more circumferential grooves to rotatably interact with and retain the filter screen. Alternatively, each roller member and include a roller engagement face for engaging and coupling with a support engagement face on each clamp support member. Each roller member can further include a fastener that can be tightened against the filter screen such that the filter screen is retained next to the axial frame member.

In one embodiment, the present invention is directed to a rotating clamp assembly for retaining one or more filter screens to a trommel frame. The rotating clamp assembly can include a pair of roller members that rotate with respect to the trammel frame for selectively engaging the filter screen. The rotating clamp assembly can further comprise a pair of clamp support members that are coupled directly to the trommel frame. The rotating clamp assembly can further comprise a roller axle for rotatably mounting the roller members to the clamp support members. In one representative embodiment, each roller member can comprise one or more grooves, wherein rotation of the roller member results in engagement of the one or more grooves with an axial frame member on the trommel frame. In another representative embodiment, each roller member and each clamp support member can comprise corresponding engagement recesses and engagement member such that rotation of each roller member allows for lockable engagement of each roller member to its corresponding clamp support member. The rotating clamp assembly can further comprise a fastening element that can engage the filter screen so as to tighten the engagement of the roller members with the filter screen.

In another representative embodiment, the present invention can be directed to a method of attaching filter screens to a trommel frame. The method can comprise the step of coupling a rotating clamp assembly to an axial frame member on the trommel frame. The method can further comprise positioning the filter screen on the trommel frame and in proximity to the axial frame member. The method can further comprise rotating a roller member on the rotating clamp assembly to engage the filter screen. In some embodiments, a step of engaging the filter screen can comprise rotating the roller member whereby a circumferential groove engages the axial frame. In some embodiments, the step of engaging the filter screen can comprise rotating the roller member such that recesses and projections on the roller member slidingly engage with a corresponding recesses and projections on a clamp support member. The method can further comprise tightening a fastener on the roller member against a panel hold down frame on the filter screen.

In another embodiment, the present invention can comprise a trommel having a trommel frame with one or more rotating clamp assemblies for rotatably coupling filter screens to the trommel.

The above summary of the various representative embodiments of the invention is not intended to describe each illustrated embodiment or every implementation of the invention. Rather, the embodiments are chosen and described so that others skilled in the art can appreciate and understand the principles and practices of the invention. The figures in the detailed description that follow more particularly exemplify these embodiments.

### BRIEF DESCRIPTION OF THE DRAWINGS

The foregoing and other advantages and features of the invention, and the manner in which the same are accomplished, will become more readily apparent upon consideration of the following detail description of the invention taken in conjunction with the accompanying drawings, which illustrate typical and exemplary embodiments and which are not necessarily drawn to scale, wherein:

FIG. 1 a is a perspective view illustrating a trommel screen apparatus, in accordance with one embodiment of the invention;

FIG. 1b is a perspective view illustrating a trommel drum assembly, in accordance with one embodiment of the invention;

FIG. 1c is a perspective view illustrating an interior section of the trommel drum assembly, in accordance with the embodiment of FIG. 1b;

FIG. 1d is a left side view of the trommel drum assembly, in accordance with the embodiment a FIG. 1b;

FIG. 1e is a right side view of the trommel drum assembly, in accordance with the embodiment of FIG. 1b;

FIG. 2a is a perspective view illustrating a filer panel assembly, in accordance with another embodiment of the invention;

FIG. 2b is an exploded perspective view illustrating the filer panel assembly, in accordance with the embodiment of FIG. 2a;

FIG. 2c is a perspective view illustrating, a section of the filter panel assembly, in accordance with the embodiment of FIG. 2a;

FIG. 3a is a perspective view illustrating a rotating clamp assembly in a hold down (locked) position, in accordance with another embodiment of the invention;

FIG. 3b is a perspective view illustrating a roller clamp structure, in accordance with the embodiment of FIG. 3a;

FIG. 3c is a perspective view illustrating the rotating clamp assembly, in accordance with the embodiment of FIG. 3a; and

FIG. 3d is a perspective view illustrating the rotating clamp assembly in an open position, in accordance with the embodiment of FIG. 3a.

FIG. 4 is a perspective view illustrating a rotating clamp assembly in a hold down (locked) position, in accordance with another embodiment of the invention.

FIG. 5 is a top view of the rotating clamp assembly in accordance with the embodiment of FIG. 4.

FIG. 6 is an end view of the rotating clamp assembly in accordance with the embodiment of FIG. 4.

FIG. 7a is a top view illustrating an embodiment of a clamp support member in accordance with the rotating clamp assembly of FIG. 4.

FIG. 7b is a perspective view of the clamp support member in accordance with the embodiment of FIG. 7a.

FIG. 7c is an end view of the clamp support member in accordance with the embodiment of FIG. 7a.

FIG. 7d is a side view of the clamp support member in accordance with the embodiment of FIG. 7a.

FIG. 8a is an end view illustrating an embodiment of a roller member in accordance with the rotating clamp assembly of FIG. 4.

FIG. 8b is a top view of the roller member in accordance with the embodiment of FIG. 8a.

FIG. 9 is a side view of an axial frame member in accordance with the rotating clamp assembly of FIG. 4.

FIG. 10 is a side view of a roller axle in accordance with the rotating clamp assembly of FIG. 4.

FIG. 11a is a perspective view of the rotating clamp assembly of FIG. 4 in an unlocked, open position.

FIG. 11b is a perspective view of the rotating clamp assembly of FIG. 4 in an unlocked and disengaged position.

FIG. 11c is a perspective view of the rotating clamp assembly of FIG. 4 in an unlocked and partially rotated position.

FIG. 11d is a perspective view of the rotating clamp assembly of FIG. 4 in a fully rotated and disengaged position.

FIG. 11e is a perspective view of the rotating clamp assembly of FIG. 4 in an locked and engaged position.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE, INVENTION

The present invention now will be described more fully hereinafter with reference to the accompanying drawings, in which some, but not all embodiments of the invention are shown. This invention may be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Certain terminology is used herein for convenience only and is not to be taken as a limitation on the embodiments described. For example, words such as “top”, “bottom”, “upper,” “lower,” “right,” “horizontal,” “vertical,” “upward,” and “downward” merely describe the configuration shown in the figures. Indeed, the referenced components may be oriented in any direction and the terminology, therefore, should be understood as encompassing such variations unless specified otherwise. Throughout this disclosure, where a process or method is shown or described, the method may be performed in any order or simultaneously, unless it is clear from the context that the method depends on certain actions being performed first.

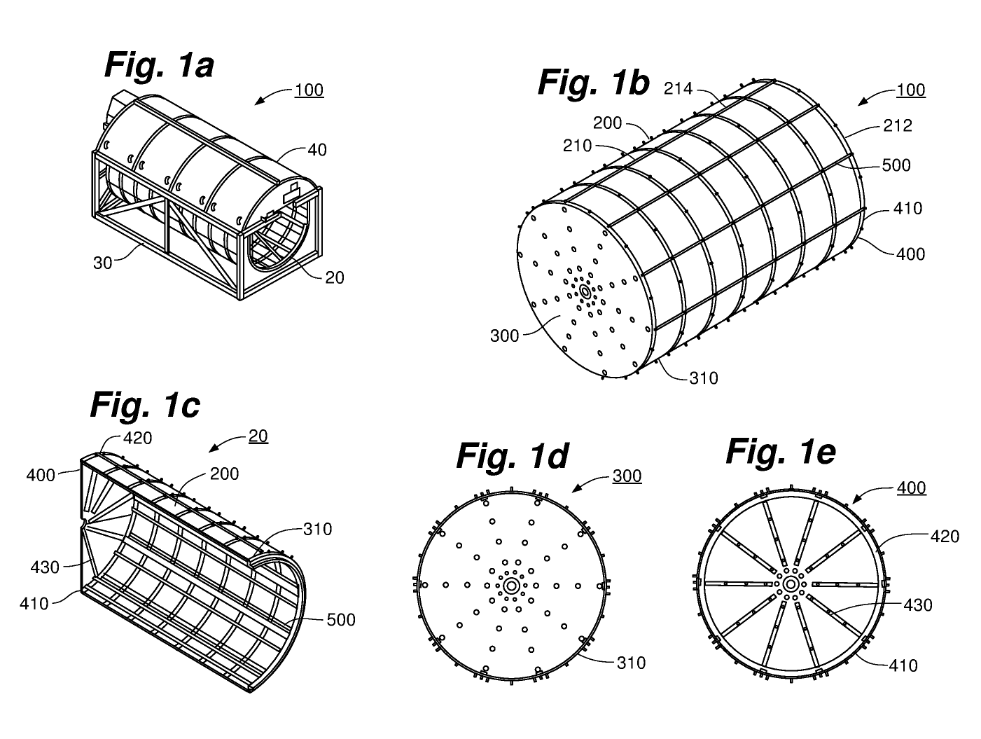

FIGS. 1 a-1e illustrate a trommel screen apparatus 100, in accordance with one embodiment of the invention. The trommel screen apparatus 100, best illustrated by FIG. 1a includes trommel drum assembly 20, support structure 30 and a housing member 40. The configuration of the drum assembly 20 is described below in detail. The support structure 30 supports the weight of the apparatus, sustains the vibratory and rotational motion of the drum assembly 20 and the housing member 40 and fixably secures the trommel screen apparatus 100 on an operating surface. In some embodiments the support structure 30 comprises a truss design. In some embodiments the support structure 30 comprises a platform support. In some embodiments the support structure 30 has a curved surface to accommodate the drum assembly 20. The support structure 30 can be made of metals, plastics, composites, concrete, any other suitable material, or combinations thereof. The support structure 30 can be constructed as a single structure or as an assembly of multiple components. The housing member 40 provides an outer cover for the trommel drum assembly 20. In some embodiments, specifically for smaller sized applications the housing member provides an outer cover for both the trommel drum assembly 20 and the support structure 30. The housing member 40 can be a curved surface a curvilinear surface, flat surfaces, any other suitable surface or combinations thereof. The housing member 40 is suitably sized with sufficient space between the inner surface of the housing member and the trommel drum assembly 20 such that the motion of the drum assembly is not hindered. In some embodiments the housing member 40 comprises access panels and doors for easy access of the trommel drum assembly 20. The housing member 40 can be constructed with plastics, metal, composites, any other material, or combinations thereof suited to the application. The trommel screen apparatus 100 can comprise more or fewer components as required for various embodiments.

FIG. 1b illustrates the trommel drum assembly 20. In accordance with one embodiment disclosed herein, the trommel drum assembly 20 is configured to rotate about a primary axis of rotation (not shown) is provided comprising a filter panel assembly 200, a trommel drum frame 210, a first end panel 300 and a second end panel 400. The primary axis can be parallel to the operating surface or can be inclined at a suitable angle. In the embodiments with the primary axis inclined with respect to the operating surface, the second end panel 400 is typically located at a higher altitude in comparison with the first end panel 300. In some embodiments, the filter panel assembly 200 and the trommel drum frame 210 comprise a substantially curved or a curvilinear contoured outer surface and extend laterally for a predetermined length along the primary axis. The cross-section of the filter panel assembly 200 and the trommel drum frame 210 can comprise a circle, an ellipse, a polygon, any other shape, or combination thereof. The trommel drum frame 210 is terminated at the ends by the first panel 300 and the second panel 400 to define an interior volume of the trommel drum assembly 20. The filter panel assembly 200 comprises one or more filter panels configured to allow fluid to pass there through while preventing particulate matter greater than a predetermined size from passing there through. In some embodiments the one or more panels of the filter panel assembly 200 are configured to filter different sizes of particles. In some embodiments the filter panel assembly proximate to the second end panel 400 filters fine particles and further filters coarser particles as the filter panel assembly extends towards the first end panel 300. In some embodiments the filter panel assembly 200 proximate to the second end panel 400 filters coarse particles and further filters finer particles as the filter panel assembly 200 extends towards the first end panel 300. In other embodiments, the filter panel assembly 200 filters the same size particles throughout.

The trommel drum frame 210 further comprises a plurality of structural members comprising circumferential frame members 212, axial frame members 214 and longitudinal support members 500. Circumferential frame members 212 may comprise concentric members, constructed with a contour substantially similar to the contour of the trommel drum assembly 20 comprising circular, elliptical or any suitable shape to conform with the shape of the drum assembly 20. The circumferential frame members 212, in some embodiments, comprise an outer curved surface defining an outer perimeter and/or diameter and a thickness, an inner curved surface defining an inner perimeter and/or diameter and two parallel lateral sides defining a depth. The circumferential frame members 212 may be designed such that the length extended along the circumference is much larger than the thickness or depth of the circumferential members 212. The circumferential frame members are typically oriented such that the axis of rotation of the circumferential frame members 212 is the primary axis. Each of the one or more panels of the filter panel assembly 200 can comprise at least one of the circumferential frame members 212. In some embodiments the one or more panels of the filter panel assembly 200 comprise circumferential frame members 212 separate from the circumferential frame members 212 corresponding to the trommel drum frame 210. In some embodiments each circumferential frame member 212 comprises one or more members with each member extending along a portion of the contour. The axial frame members 214 are straight, curved or helical members such that they connect a pair of circumferential frame members 212 at their ends. The plurality of axial frame members 214 can be oriented parallel, inclined or a combination of both, with respect to the primary axis. In some embodiments the circumferential frame members 212 together with the axial frame members 214 define a truss structure of the trommel drum frame 210. In some embodiments the axial frame members 214 are arranged such that the ends of adjacent axial frame members 214 are connected. In some embodiments the axial frame members 214 are arranged along continuous lines perpendicular to the outer curved surface of the circumferential frame members 212. In some embodiments the axial frame members 214 have a staggered arrangement. The trommel drum frame 210 further comprises longitudinal support members 500, best illustrated in FIG. 1 c, which typically extend throughout the length of the trommel drum assembly 20. The longitudinal support members 500 are joined to the filter panel assembly 200 at multiple locations along the inner curved surfaces of the circumferential frame members 212. The longitudinal support members 500 are typically oriented parallel to the primary axis, although they can be oriented at a suitable angle based on the application.

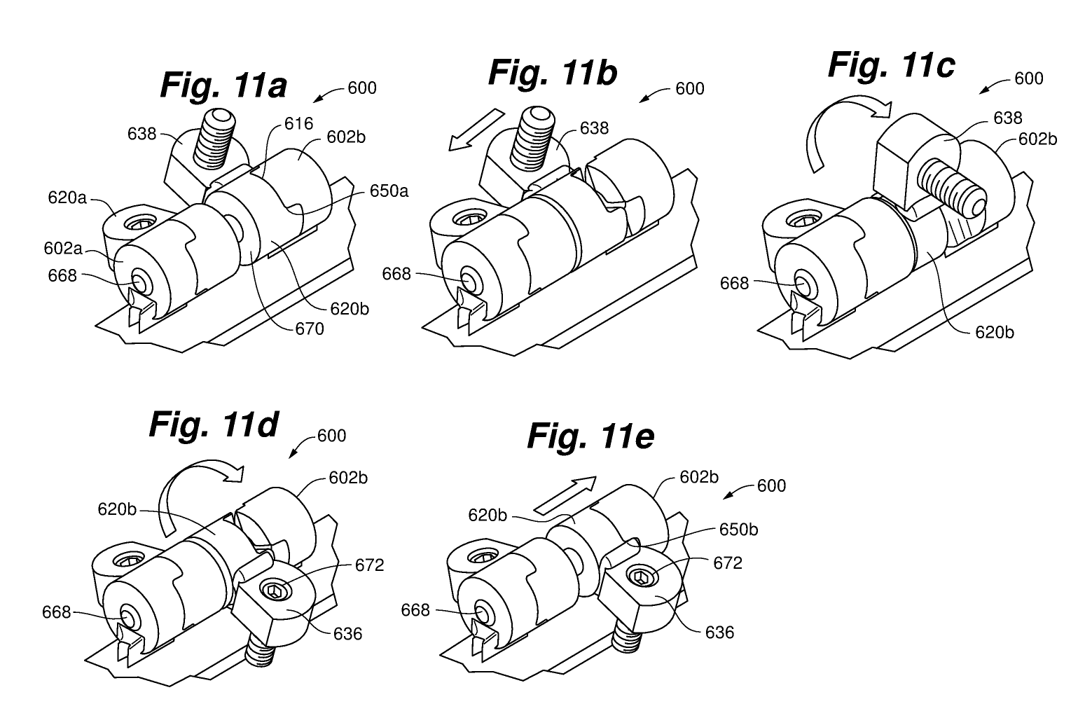

The trommel drum assembly 20 further comprises the first end panel 300, best illustrated in FIGS. 1b and 11d. The first end panel 300 is a disc like member with an outer surface, an inner surface facing the interior volume and a thickness. The outer surface and the inner surface of the first end panel 300 have a contour similar to the contour of the trommel drum frame 210. In some embodiments the first end panel 300 may be a solid surface with radial support arms 330. The first end panel 300 may be operatively coupled to a support shaft (not illustrated) to support the trammel drum assembly 20 and allow the trammel drum assembly 20 to rotate. In other embodiments, the first end panel 300 comprises an outlet at the intersection of the primary axis and the first end panel 300. In addition, the first end panel 300 may comprise a plurality of apertures and/or screens to allow the filtered fluid to flow out of the interior volume. The apertures are typically smaller than the outlet, although the apertures could be varying in size. The apertures can be arranged in any suitable arrangement. The first panel 300 further comprises a first fixing frame 310. The first fixing frame 310 enables the first panel 300 to be secured to the trommel drum frame 210. In some embodiments the first fixing frame 310 is a part of the trommel drum frame 210 configured to receive the first end panel 300.

In some embodiments the trammel drum assembly 20 may have only a first end panel 300 and the second end may be open. In other embodiments, the trommel drum assembly 20 further comprises the second end panel 400, best illustrated in FIGS. 1c and 1e. The second end panel 400 may be like the first end panel 300 in some embodiments. As such, in some embodiments the second end panel 400 (and/or the first end panel 300), may be a wheel-like member with an outer race 420 having a contour similar to the contour of the trommel drum frame 210 and a thickness. The second panel 400 (and/or the first end panel 300) further comprises radial arms 430 (e.g., straight bars, or the like) extending from the outer race 420 inwards towards the primary axis. The radial arms 430 can be perpendicular or inclined with respect to the outer race 420. The radial arms 430 can be spaced with similar angular orientation, symmetric about the primary axis or any other suitable arrangement. The second end panel 400 may further comprise a second fixing frame 410. The second fixing frame 410 enables second end panel 400 to be secured to the trommel drum frame 210. In some embodiments the second fixing frame 410 is a part of the trommel drum frame 210 configured to receive the second panel 400. The ends of the longitudinal support members 500 are typically joined to the first fixing frame 310 near the first panel 300 and joined to the second fixing frame 410 near the second panel 400. The second end panel 400 comprises an inlet for the fluid to be filtered. In a typical embodiment the unfiltered fluid enters through the second end panel 400 and enters the interior volume as the trommel drum assembly 20 rotates with respect to the primary axis. Particles larger than a predetermined size are trapped within the interior volume. Filtered fluid then leaves the interior volume through the filter panel assembly 200. In some embodiments filtered fluid may also leave the interior volume through an outlet of the first end panel 300.

As such, it should be understood that the trommel drum assembly 20 may have ends that are closed or open. In some embodiments, the closed ends may have inlets that allow for the water and/or particles in the water to enter, and exits that allow the particles to exit while the filtered water flows through the screens. In some embodiments the inlets and outlets may be located on different ends of the trommel drum assembly 20 or on the same ends.

The trommel screen apparatus 100 is designed based on desired values of factors comprising screening rate, screening efficiency, residence time, production rate. Other factors considered are fluid rotational velocity, slumping, cataracting and centrifuging particle motions fluid properties and the like. The desired vales can be attained based on heuristics and varying the mass flow rate of the particles, size of the drum, rotational velocity, inclination of the primary axis, feed rate and the like. The structural members of the trommel drum frame 210, the first end panel 300 and the second end panel 400 can be operatively coupled using threaded fasteners, clamps, bolts, locks, clips, pins, or any other suitable attachments. The structural members can be fastened with gaskets or other members to provide a waterproof connection and to prevent galvanic corrosion. In some embodiments the members are permanently fastened using welding, brazing or any other suitable means. The trommel drum frame 210 can be manufactured from metals, composites or any other suitable materials. In some embodiments a portion of the trommel drum frame 210 is fabricated out of a different material than the rest. In some embodiments the entire trommel drum frame 210 is manufactured out of a single material. In some embodiments the structural members of the trommel drum frame comprise surface coatings for corrosion prevention properties, fluid repelling properties, coatings to prevent adherence of particles and the like.

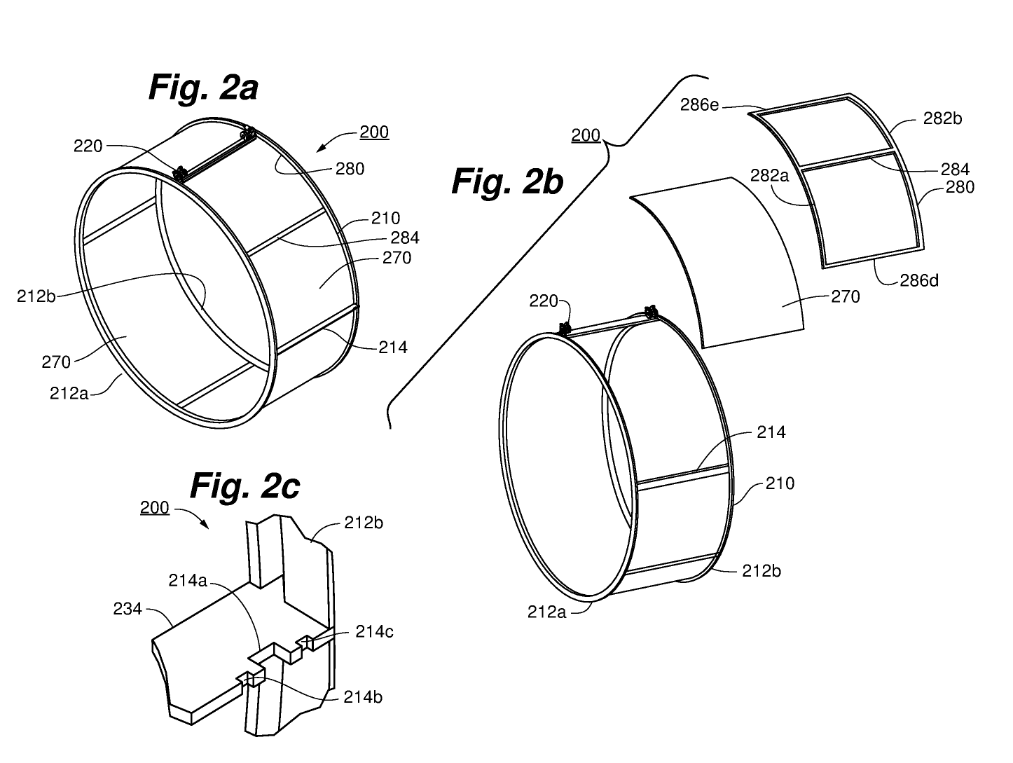

Now referring to FIGS. 2a-2c. FIGS. 2a and 2b illustrate the filter panel assembly 200 with filter 2b illustrating the exploded view. The filter assembly 200 comprises a trommel drum frame 210, a filter panel 270 and a panel hold down frame 280. As described above the trommel drum frame 210 comprises circumferential frame members (212a, 212b) and axial frame members 214. The trommel drum frame 210 further comprises rotating clamp assembly 220 typically positioned on the axial frame members 214, proximate to the circumferential frame members (212a, 212b). In the typical embodiment each axial frame member 214 has a pair of rotating clamp assemblies 220, although the rotating clamp assemblies 220 can be arranged any suitable manner. The rotating clamp assemblies 220 will be described in greater detail below. The filter panel 270 typically comprises a curved surface substantially similar to the contour of the trommel drum frame 210. However, the filter panel 270 may have any shape. The filter panel 270 may comprise a single filter panel extending throughout the circumference of the trommel drum frame 210 or can comprise multiple filter panels 270 each covering a portion of the trommel drum frame 210. The embodiment with multiple filter panels has the advantage of easy removal and replacement of the filter panels 270.

Although the outside surface of the filter panel 270 appears smooth, the filter panel 270 is formed with a plurality of openings or apertures. In some embodiments the filter panel 270 is constructed out of spirally wrapped wires that form slots and serve as a filtration material. In some embodiments, the filter panel 270 may include as filtration material, a plurality of spaced filter wires, or a wire mesh supported on support rods (not shown). The filter panel 270 is constructed out of one or more screens of filtration material. In some embodiments, the screens may include “Vee-Wire” type screens. In some embodiments, the filter panel 270 may include as filtration material, plates (not shown) having perforations, slots, or other filter-type openings. In some embodiments, the spacing and sizes of wires, or other openings, vary along the length or the circumference of the filter panel 270. In some embodiments, the filter panel 270 may include as filtration material any combination of wires and plates.

In the “Vee-Wire” type of screen, a filtering surface is formed by wires with a V-shaped cross-section, meaning that they each have a generally triangular-shaped cross-section and which are parallel at constant intervals, the space between wires forming the slots of the screen. The wires can be constructed out of circular, polygonal, or any other suitable cross-section based on requirements. In some embodiments these wires are welded to filter support rods (not shown) oriented essentially perpendicularly with respect to the wires, and may be relatively thin in order to maximize the effective opening of the slots. Such a filter panel 270 may have the advantage of being very strong and being resistant to clogging. The filter panel 270 allows fluids and specifically liquids, to pass through it, while preventing particulate matter greater than a certain size from entering the interior volume of the trommel drum assembly 20. Each wire includes an outer surface and two side surfaces which may converge to a point or another surface based on the cross-section of the wires. The wires are aligned, side-by-side, with their face surfaces lying in a plane to form a set of wires. Multiples sets of wires can be arranged at angle with each other in the same plane and joined to form the filter panel 270. Therefore, the one or more set of wires creates the outer surface of the filter panel 270 and defines the interior volume. Furthermore, the sets of wires and the filter support rods, if any are present, can be constructed out of metals, composites, plastics, coated materials, natural or synthetic materials based on the desired properties and ease of manufacture.

After cylinder screen is created it may be bent in the desired form to create a contour for filter panel 270 that conforms to the contour of the trommel drum frame 210, as illustrated by FIGS. 2a and 2b. In some embodiments of the invention the screen may be created along a flat surface or other shaped surface, bent into the desired shape. When using wires of V-shaped cross-section, a channel is created between opposing side surfaces of consecutive wires. Because of the triangular shaped cross-section of the wires in one embodiment, the channels between consecutive wires open away from the plane defined by the face surfaces of the filter wires. Put another way, the filter channels do not have parallel walls, but instead flare from the face surfaces to the points of the wires.

The filter panel assembly further comprises the panel hold down frame 280, best illustrated in FIG. 2b, to help support and secure the filter panel 270 to the trommel drum frame 210. The panel hold down frame 280 supports at least a portion of the filter panel 270. In the typical embodiment each panel hold down frame 280 supports one filter panel 270. However, in some embodiments the panel hold down frame 280 supports more than one filter panels 270. The panel hold down frame 280 further comprises circumferential hold down members (282a, 282b) and outer support hold down members (286c, 286d). The circumferential hold down members (282a, 282b), together with the outer support hold down members (286c, 286d) define the contour of the panel hold down frame 280. In some embodiments the panel hold down frame 280 further comprises one or more inner support members 284 for structural support and added strength. The inner support members 284 can be straight, curved, or helical rods with ends joined to the circumferential hold down members (282a, 282b) and/or the outer support hold down members (286c, 286d). The panel hold down frame 280 has a contour identical to that of the trommel drum frame 210 and the filter panel 270. While the filter panel 270 can be welded to the trommel drum frame 210 and/or the panel hold down frame 280, it is typical that the filter panel is releasably secured to ensure easy removal, replacement and maintenance. In this regard, the typical embodiment utilizes the rotating clamp assembly 220 to secure the panel hold down frame 280 to the trommel drum frame 210 with the filter panel 270 in between. In some embodiments the rotating clamp assembly 220 secures the filter panel 270 and the panel hold down frame 280 separately to the trommel drum frame 210. Furthermore, the panel hold down frame 280 can be rigid or flexible based on the desired characteristics and the properties of the material used.

Referring now to FIG. 2c, illustrating a magnified section of the trommel drum frame 210. The figure illustrates the joint between the circumferential frame member (212a or 212b) and the axial frame member 214. The axial frame member comprises frame grooves or notches 214a, 214b and 214c. Each groove has a width extending the outer surface and along the length of the axial frame member 214 and defines a depth extending inwards towards the primary axis. The shape of the frame grooves 214a, 214b and 214c can be triangular, rectangular, square, polygonal or any other suitable curvilinear shape. However, the typical embodiment illustrated in FIG. 2c, shows grooves with a substantially quadrilateral shape. The width and depth of the frame groove 214a may be greater than the width and the depth of the frame grooves 214b and 214c. In some embodiments, the axial frame members 214 comprise the frame groove 214a and only one other frame groove 214b or 214c. In some embodiments the axial frame members 214 can comprise additional frame grooves in addition to the frame grooves 214a, 214b and 214c. The frame grooves 214b and 214c receive and secure one or more members of the rotating clamp assembly 220 and the frame groove 214a enables the locking (holding down) and the unlocking (opening) of the rotating clamp assembly 220. The depth and the width of the frame grooves (214a, 214b and 214c) is designed to accommodate the shape of the rotating clamp assembly 220.

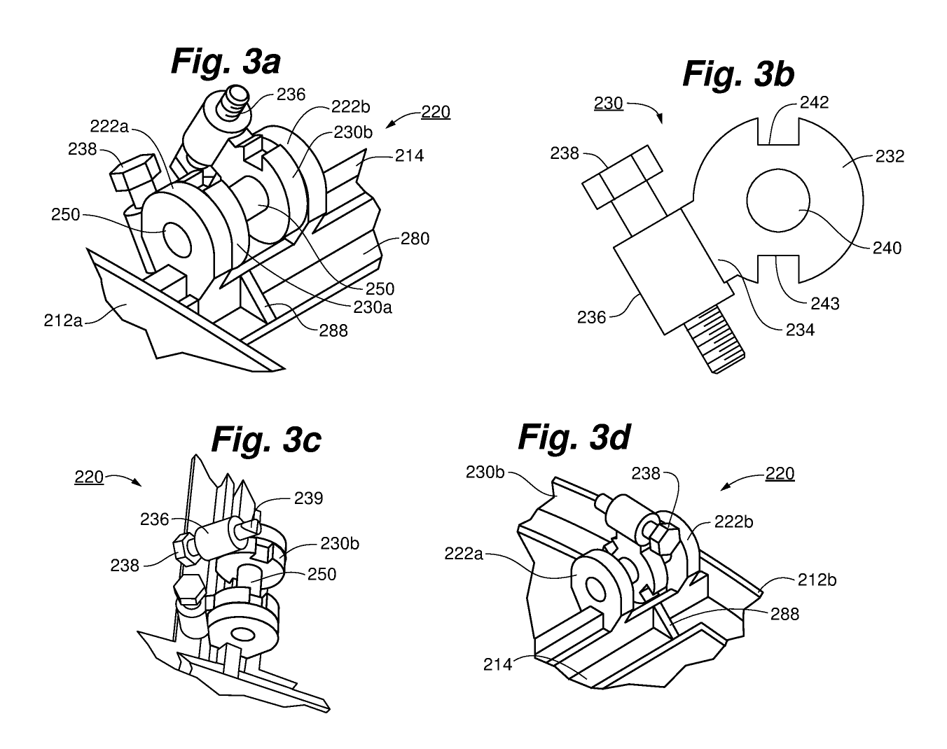

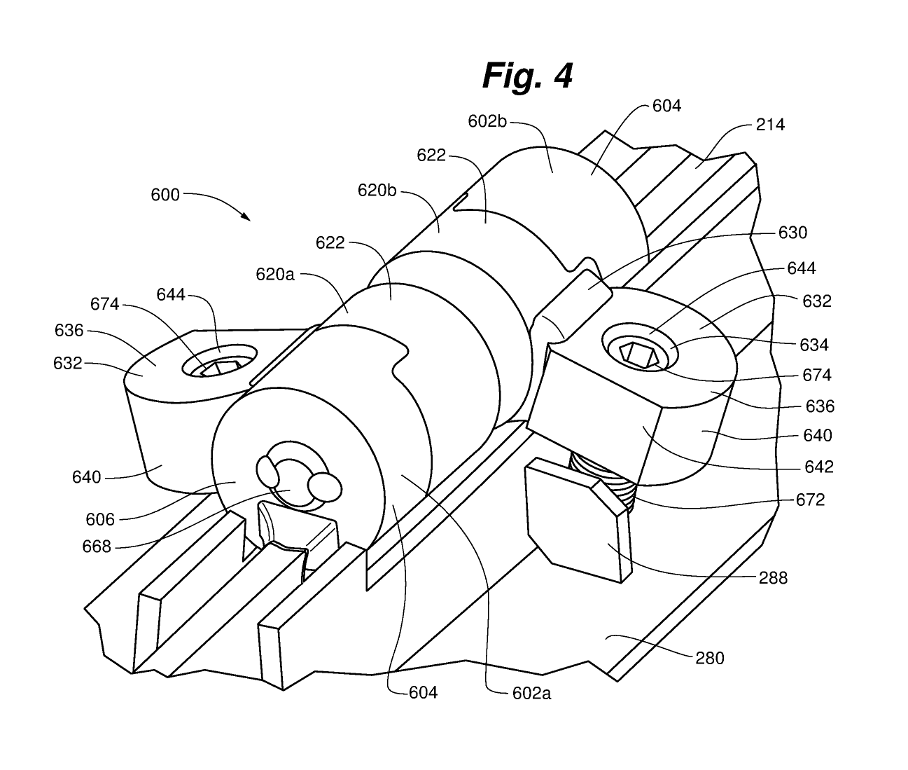

FIG. 3a illustrates the rotating clamp assembly 220 and the associated components. The rotating clamp assembly 220 comprises one or more clamp support members 222a and 222b. The clamp support members 222a, 222b are illustrated as substantially circular discs. However, they may be any other type of shape. The clamp support members 222a, 222b are operatively coupled to the axial frame member 214, such that they engage with and are operatively coupled to the frame grooves 214b, 214c of the axial frame member 214. The clamp support members 222a, 222b may have recesses that engage with the frame grooves 214b, 214c. In some embodiments, the clamp support members 222a, 222b are welded, or the like, to the axial frame member 214. As such, the clamp support members 222a, 222b may be permanently or releasably operatively coupled to the axial frame members 214. The clamp support members 222a, 222b are typically mounted perpendicular to the axial frame members 214, although any other suitable orientation may be utilized. The clamp support members 222a, 222b may each have a central bore to engage a roller axle 250 mounted between them. The roller axle 250 is typically a shaft of a suitable cross-section and length either permanently or releasably, operatively coupled to the clamp support members 222a, 222b. In some embodiments, the roller axle 250 is operatively coupled between one clamp support member and a raised edge of the circumferential frame member 212a (not shown). In other embodiments, the roller axle 250 is operatively coupled between the two clamp support members 222a, 222b. The rotating clamp assembly 220 further comprises at least one roller clamp structure 230 best illustrated in FIG. 3b. The roller clamp structure 230 further comprises a substantially circular roller member 232 with a tab 234 extending on one side. In other embodiments of the invention roller member 232 does not have to be circular, and can be any type of shape. The roller member 232 defines two parallel surfaces and a thickness between them. The thickness of one or more of the roller members 232 is typically smaller than the width of the frame groove 214a. The roller member 232 comprises a central bore to enable the roller member 232 to be mounted on the roller axle 250.

The roller member 232 also comprises at least a pair of circumferential grooves 242 and 243, wherein, in some embodiments one of the circumferential grooves is closer to the tab 234 than the other to facilitate the operation of the rotating clamp assembly 220. The circumferential grooves 242, 243 may be arranged diagonally opposite to each other such that each roller clamp structure can be used to fasten a panel hold down frame 280 and the associated filter panel 270 on the left side or the right side by merely rotating it with respect to the roller axle 250. Other arrangements can also be used based on the desired functionality. For instance multiple circumferential grooves 242, 243 may be present around the circumference for precision clamping that can be adjusted during operation based on various requirements. The circumferential grooves 242, 243 each comprise a depth extending from the circumference of the roller member 232 inwards towards the central bore 240 and a width, in the plane of a parallel surface of the roller member 232 and perpendicular to the depth. The width of the circumferential grooves 242, 243 is typically at least slightly larger than the width of the axial frame member 214 to enable the roller clamp structure 230 to slide along the length of the axial frame member 214. The roller clamp structure further comprises a receiving member 236 mounted on the tab 234 with a bore to receive a rotating fastener 238. The receiving member 236 is located substantially tangential to the surface of the roller member 232. The rotating fastener 238 may be a threaded fastener or any other suitable fastener.

The rotating clamp assembly 220 may be arranged in the typical embodiment, as depicted in FIG. 3a, such that the frame groove 214a lies in between a pair of the roller clamp structures 230a, 230b, between a pair of the clamp support members 222a, 222b and along the length of the roller axle 250. However, some embodiments can comprise a single roller clamp structure 230b (illustrated in FIG. 3d) between a pair of clamp support members 222a, 222b instead of a pair as illustrated in FIGS. 3a and 3c. Furthermore, the roller clamp structures 230a, 230b are arranged facing each other such that the threaded fastener 238 can fasten the panel hold down frame 280 on one side of the rotating clamp assembly 220. In this regard, it is observed that multiple arrangements of the members are possible with many more or fewer components described above. In one embodiment, the one or more roller clamp structures 230, are mounted on the roller axle 250 and should be able to slide along the axial frame member 214 and slide into the frame groove 214a without removal or modification of the other parts.

To operate the rotating clamp assembly 220, the roller clamp structures 230a, 230b are mounted on the roller axle 250 and the assembly is mounted on the clamp support members 222a, 222b such that one of the circumferential grooves 242, 243 engage with the axial frame member 214. The roller clamp structures 230a, 230b slide along the roller axle 250 with respect to the axial frame member 214 into a position above frame groove 214a, such that the roller clamp structures 230a, 230b can be rotated to a suitable position (e.g., both to one side or the other of the axial frame member) for installation of the filter panel 270 and the hold down frame 280. Once the panel filter 270 and the panel hold down frame 280 are in position, one of the roller clamp structures 230b can be rotated back into frame groove 214a, such that the roller clamp structure 230b may be rotated to a position in which the opposite circumferential groove 242 may be slid to engage with the axial frame member 214. Then, the roller clamp structures 230a, 230b may be locked into a position by engaging the circumferential grooves 242, 243 (as illustrated in FIG. 3a and FIG. 3c) with the axial frame member 214. The roller clamp structures 230a, 230b may then be slid along the length of the axial frame member 214 to a predetermined position.

The panel hold down frame 280, and thus the filter panel 270, may be secured and/or tightened into place by rotating the fastener 238. As such, the fastener 238 may be utilized as a fine tuning of the fastening force for creating a seal between the hold down frame 280, the filter panel 270 and the trammel drum frame 210. In other embodiments the fastener may be turned into the desired position before rotating the roller clamp structure 230b into the desired portion for securing the panel hold down frame 280, the filter panel 270, and the trammel drum frame 210, in order to create a quick connect feature between the components. To remove the panel, the threaded fasteners may be unfastened, and/or the roller clamp structures 230a, 230b are slid back into frame groove 214a and rotated to remove the panels.

In some embodiments the fastener 238 may have an edge or a point 239 that allows the fastener 238 to turn for fine tuning when the roller clamp structures 230a, 230b are in the locked position. In some embodiments, instead of utilizing fasteners 238, quick connect fastener clamps may be utilized that can be pushed or clamped into place without having to turn a fastener. The invention is configured such that the rotation of the roller clamp structure 230 is constrained when it engages with the axial frame member 214. Rotation of the roller clamp structure 230 is only possible when the roller clamp structure is slid into the frame groove 214a. Then, when the rotating fastener 238 is engaged, the linear or sliding motion of the rotating clamp assembly 220 is constrained. Therefore, when the rotating clamp assembly is engaged to secure the filter panel 270 and the panel hold down frame 280, the rotation and linear motion of the assembly is constrained thereby providing secure clamping capable of withstanding vibrational, torsional and other loads. In some embodiments, illustrated in FIGS. 3c and 3d, the flanges 288 (e.g., angled flanges, stops, or the like), on the filter panel hold down frame 280, further prevent the roller clamp structure 230 from moving along the roller axle 250 when the rotating fastener 238 and/or the receiving member 236 engages a flange 288. Furthermore, FIG. 3d illustrates the rotation of the roller clamp structure 230b after sliding it into the frame groove 214a. In the embodiments with a pair of roller clamp structures 230a, 230b, each roller clamp structure can engage a panel on either side or on the same side of the rotating clamp assembly 220.

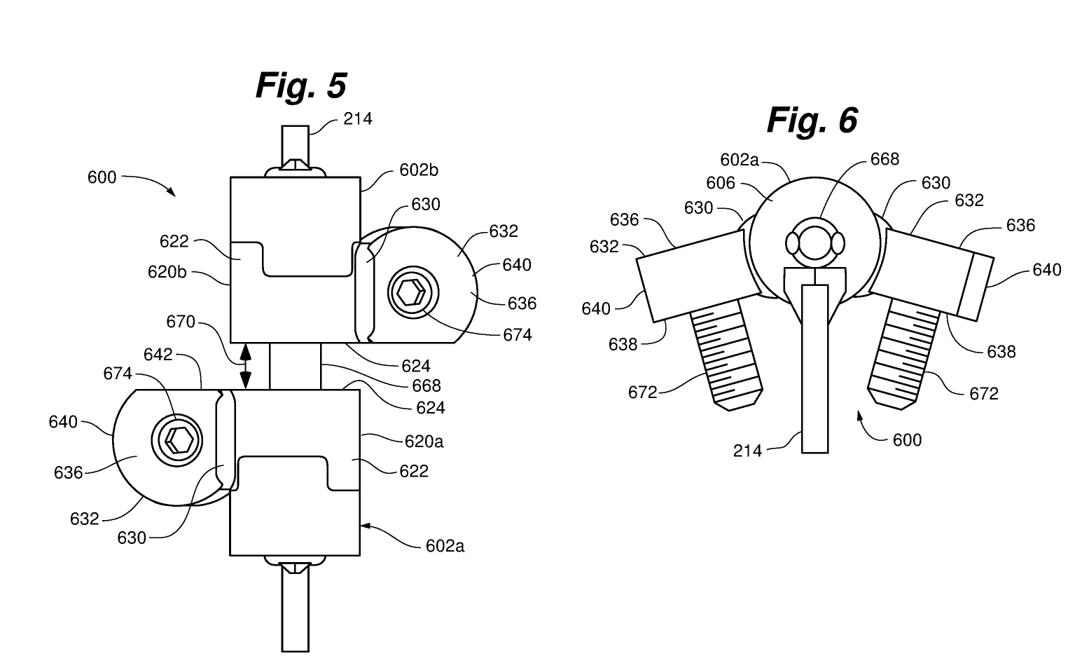

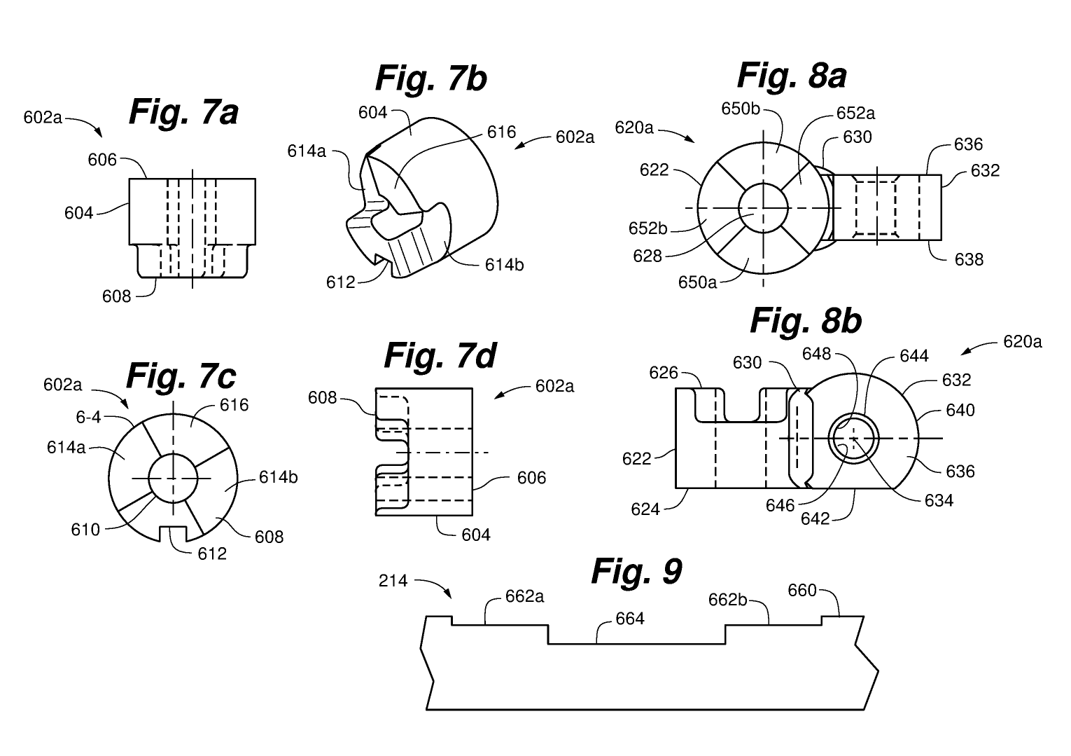

Referring now to FIGS. 4, 5 and 6, another representative embodiment of a rotating clamp structure 600 can comprise a pair of clamp support members 602a, 602b Clamp support member 602a is individually illustrated in FIGS. 7a, 7b, 7c and 7d. Though not individually illustrated. It will be understood that clamp support member member 602b substantially resembles the illustrations in FIGS. 7a, 7b, 7c and 7d. As illustrated, each clamp support member 602, 602b can comprise a substantially circular body 604 defined between a support end face 606 and a support engagement face 608. Each clamp support member 602a, 602b can further comprise a central bore 610 extending between the support end face 606 and the support engagement face 608. The circular body 604 can further define an elongated notch 612 that extends between the support end face 606 and the support engagement face 608. As illustrated, the support end face 606 can define a substantially planar surface though it will be understood that the support end face 606 could comprise other profiles including, for example, angled, curved and semi-spherical shapes. Support engagement face 608 generally includes a pair of support engagement recesses 614a, 614b that define a support engagement member 616.

Rotating clamp structure 600 further comprises a pair of roller members 620a, 620b as illustrated in FIGS. 4, 5 and 6 and as individually illustrated with respect to roller member 620a in FIGS. 8a and 8b. Though not individually illustrated, it will be understood that roller member 620b substantially resembles the illustrations in FIGS. 8a and 8b. Each roller member 620a, 620b can comprise a substantially circular roller body 622 extending between an inner face 624 and a roller engagement face 626. Each roller member 620a, 620b further comprises a roller bore 628 extending between the inner face 624 and the roller engagement face 626. Circular roller body 622 can further comprise a tab 630. Tab 630 can comprise a fastener body 632 including a fastener bore 634 extending between an upper surface 636 and a lower surface 638. Fastener bore 634 generally resides along an axis oriented perpendicular to an axis of the roller bore 628. Fastener body 632 generally defines an exterior perimeter 640 including defining at least one planar fastener surface 642. Exterior perimeter 640 can define other planar surface or can comprise other angled, curved or semi-spherical surfaces as well. Fastener bore 634 generally includes an enlarged diameter portion 644 proximate the upper surface 636 and a reduced diameter portion 646 proximate the lower surface 638. The reduced diameter portion 642 further comprises an internal threaded surface 648. Roller engagement face 626 generally includes a pair of roller engagement recesses 650a, 650b that define a pair of roller engagement members 652a, 652b. Generally, each roller engagement recess 650a, 650b is shaped and dimensioned to snugly receive the support engagement member 616 while the support engagement recesses 614a, 614b are shaped and dimensioned to snugly receive the roller engagement members 652a, 652b.

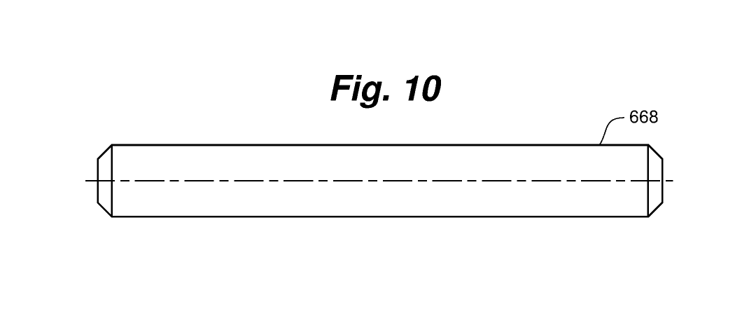

Rotating clamp structure 600 mounts to the axial frame member 214 in a different manner than that previously described with respect to rotating clamp assembly 220. Axial frame member 214 includes a mounting profile 660 that replaces the frame grooves 214a, 214b, 214c with a pair of end notches 662a, 662b and a center notch 664 as illustrated in FIG. 9. Generally, clamp support members 602a, 602b are positioned such that the elongated notch 612 sets into and over the corresponding end notch 662a, 662b, whereby the clamp support members 602a, 602b can be welded to the axial frame member 214 to operably connect the rotating clamp structure 600 to the axial frame member 214. With the clamp support members 602a, 602b fixed to the axial frame member 214, the roller members 620a, 620b can be positioned over the center notch 664 with each roller engagement face 626 facing the corresponding support engagement face 608. In order to simplify assembly, each roller engagement face 626 can be engaged to the corresponding support engagement face 608. With the clamp support members 602a, 602b and the roller members 620a, 620 positioned with respect to the axial frame member 214, a roller axle 668 as shown in FIG. 10 is inserted through the central bore 610 of the clamp support members 602a, 602b and the roller bore 628 of the roller members 620a, 620b. In this manner, the roller members 620a, 620b are rotatably mounted to the axial frame member 214 and thereby define a clamp gap 670 between the inner face 624 of the roller members 620a, 620b.

With reference to FIGS. 11a, 11b, 11c, 11d and 11e, rotating clamp structure 600 functions to rotatably engage and retain the panel hold down frame 280 of the associated filter panel 270 as shown in FIG. 4. Generally, roller member 620b can be in a disengaged orientation 670 in which the support engagement member 616 of clamp support member 602b is positioned within the roller engagement recess 650a as shown in FIG. 11a. The roller member 620b is directed to slide along the roller axle 668 and into the clamp gap 670 such that the roller member 620b approaches roller member 620a and the roller engagement recess 650a is directed away from the support engagement member 620b as shown in FIG. 11b. The roller member 620b is then spun about the roller axle 668 such that the lower surface 638 approaches the panel hold down frame 280 as shown in FIGS. 11c and 11d. The roller member 620b is slid along the roller axle 668 such that the support engagement member 616 is directed into the roller engagement recess 650b as shown in FIG. 11e. Using a suitable tool, a fastener 672 is tightened within the fastener bore 634. As the fastener 672 is tightened and advanced out of the fastener bore 634, the fastener 672 engages the panel hold down frame 280 as illustrated in FIG. 4. In addition, the fastener 672 interfaces with flange 288 on the hold down frame 280 to prevent the roller member 620b from unintentionally sliding into the clamp gap 670, whereby the roller member 620b could disengage from the clamp support member 602b. Due to the interlocking nature of the support engagement member 616 and the roller engagement recess 650b, rotation of the roller member 620b is prevented such that the panel hold down frame 280 is captured and retained with respect to the axial frame member 214. Due to the enlarged diameter portion 644, an engagement head 674 of fastener 672 is essentially countersunk below the upper surface 636 such that the engagement head 674 is protected from any damage during operation of the trammel screen apparatus 100. While not described, it will be understood that roller member 620a operates in a similar fashion to capture and retain an adjacent panel hold down frame 280 on an opposed side of the axial frame member 214 from roller member 620b.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation. In addition, where possible, any terms expressed in the singular form herein are meant to also include the plural form and/or vice versa. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein.

1. A filter panel assembly for a trommel drum, the filter panel assembly comprising:
a trommel drum frame comprising:
at least two circumferential frame members;
at least one axial frame member operatively coupling the two of the at least two circumferential frame members;
at least one filter panel;
at least one panel hold down frame; and
a rotating clamp assembly operatively coupling the trommel drum, the filter panel, and the panel hold down frame, wherein the rotating clamp assembly comprises:
at least one clamp support member that is operatively coupled to an axial frame member;
at least one roller axle operatively coupled to the clamp support;
at least one roller clamp structure that is operatively coupled to the roller axle, wherein the roller clamp structure can slide with respect to the roller axle and rotate around the roller axle; and
wherein the roller clamp structure is configured to move between a first unlocked position and a locked position by sliding the roller clamp structure along the roller axle and rotating the roller clamp structure around the roller axle.

2. The filter panel assembly of claim 1, wherein the at least one clamp support member further comprises a first clamp support member and a second clamp support member and wherein the at least one roller axle is disposed between the first clamp support member and the second clamp support member.

3. The filter panel assembly of claim 1, wherein the at least one roller clamp structure operatively coupled to the roller axle further comprises a first roller clamp structure and a second roller clamp structure, wherein the first roller clamp is configured to secure a first of the at least one panel hold down frame and a first of the at least one filter panel disposed on a first lateral side and wherein the second roller clamp is configured to secure a second of the at least one panel and a second of the at least one filter panel disposed on a second lateral side opposite the first lateral side.

4. The filter panel assembly of claim 1, wherein the at least one axial frame member further comprises:
a primary groove disposed on a surface of the at least one axial frame member defining a first width and a first depth; and
at least one secondary groove disposed on the surface of the at least one axial frame member defining a second width and a second depth, wherein the first width is greater than the second width, wherein the first depth is greater than the second depth.

5. The filter panel assembly of claim 4, wherein the at least one roller clamp structure further comprises a first circumferential groove and an opposite second circumferential groove, wherein the roller clamp structure is configured to slide along the roller axle a first linear direction to the locked position by engaging the first circumferential groove with the at least one axial frame member.

6. The filter panel assembly of claim 5, wherein the at least one roller clamp structure is configured to slide along the roller axle to the unlocked position by sliding the roller clamp structure along a second linear direction opposite to the first linear direction to the primary groove and disengaging the first circumferential groove from the at least one axial frame member, wherein the primary groove is at the unlocked position.

7. The filter panel assembly of claim 5, wherein the rotation of the at least one roller clamp structure is constrained at the locked position.

8. The filter panel assembly of claim 5, wherein the at least one roller clamp structure further comprises a fastener configured to secure the at least one panel hold down frame and the at least one filter panel.

9. The filter panel assembly of claim 8, wherein the fastener is configured to secure the at least one panel hold down frame and the at least one filter panel by
rotating the at least one roller clamp structure at the unlocked position;
engaging the second circumferential groove with the axial frame member;
sliding the at least one roller frame along the roller axle to the locked position; and
engaging the fastener with the at least one panel hold down frame.

10. The filter panel assembly of claim 4, wherein the at least one clamp support member is operatively coupled to the at least one secondary groove.

11. The filter panel assembly of claim 1, wherein the at least one axial frame member further comprises:
a mounting profile primary groove disposed on a surface of the at least one axial frame member, the mounting profile including a pair of end notches and a center notch, wherein each clamp support member mounts within one end notch.

12. The filter panel assembly of claim 11, wherein the at least one roller clamp structure further comprises a roller engagement face including a pair of roller engagement recesses and a pair of roller engagement members, and wherein the at least one clamp support member further comprises a support engagement face including a pair of support engagement recesses and a support engagement member.

13. The filter panel assembly of claim 12, wherein the at least one roller clamp structure is configured to slide along the roller axle to the unlocked position by sliding the roller clamp structure along the roller axle wherein the roller engagement face is disengaged from the support engagement face.

14. The filter panel assembly of claim 12, wherein the at least one roller clamp structure is configured to slide along the roller axle to the locked position by sliding the roller clamp structure along the roller axle wherein the roller engagement face engages the support engagement face.

15. The filter panel assembly of claim 14, wherein the at least one roller clamp structure further comprises a fastener configured to secure the at least one panel hold down frame and the at least one filter panel.

16. The filter panel assembly of claim 15, wherein the fastener is configured to secure the at least one panel hold down frame and the at least one filter panel by
rotating the at least one roller clamp structure at the unlocked position;
sliding the at least one roller clamp structure along the roller axle to the locked position; and
engaging the fastener with the at least one panel hold down frame.

17. The filter panel assembly of claim 16, wherein an engagement head of the fastener is countersunk below an upper surface on the roller clamp structure.

18. A clamp assembly operatively coupling a trommel drum, a filter panel, and a panel hold down frame, wherein the clamp assembly comprises:
a clamp support member that is operatively coupled to an axial frame member;
a roller axle operatively coupled to the clamp support;
a roller clamp structure that is operatively coupled to the roller axle, wherein the roller clamp structure can slide with respect to the roller axle and rotate around the roller axle; and
wherein the roller clamp structure is configured to move between a first unlocked position and a locked position by sliding the roller clamp structure along the roller axle and rotating the roller clamp structure around the roller axle.

19. The clamp assembly of claim 18, wherein the at least one clamp support member further comprises a first clamp support member and a second clamp support member and wherein the at least one roller axle is disposed between the first clamp support member and the second clamp support member.

20. The clamp assembly of claim 18, wherein the at least one roller clamp structure operatively coupled to the roller axle further comprises a first roller clamp structure and a second roller clamp structure, wherein the first roller clamp is configured to secure a first of the at least one panel hold down frame and a first of the at least one filter panel disposed on a first lateral side and wherein the second roller clamp is configured to secure a second of the at least one panel and a second of the at least one filter panel disposed on a second lateral side opposite the first lateral side.

21. The clamp assembly of claim 18, wherein the trommel drum comprises an at least one axial frame member, wherein the at least one axial frame member further comprises:
a primary groove disposed on a surface of the at least one axial frame member defining a first width and a first depth; and
at least one secondary groove disposed on the surface of the at least one axial frame member defining a second width and a second depth, wherein the first width is greater than the second width, wherein the first depth is greater than the second depth.

22. The clamp assembly of claim 21, wherein the at least one roller clamp structure further comprises a first circumferential groove and an opposite second circumferential groove, wherein the roller clamp structure is configured to slide along the roller axle a first linear direction to the locked position by engaging the first circumferential groove with the at least one axial frame member.

23. The clamp assembly of claim 22, wherein the at least one roller clamp structure is configured to slide along the roller axle to the unlocked position by sliding the roller clamp structure along a second linear direction opposite to the first linear direction to the primary groove and disengaging the first circumferential groove from the at least one axial frame member.

24. The clamp assembly of claim 22, wherein the rotation of the at least one roller clamp structure is constrained at the locked position.

25. The clamp assembly of claim 22, wherein the at least one roller clamp structure further comprises a fastener configured to secure the at least one panel hold down frame and the at least one filter panel.

26. The clamp assembly of claim 25, wherein the fastener is configured to secure the at least one panel hold down frame and the at least one filter panel by
rotating the at least one roller clamp structure at the unlocked position;
engaging the second circumferential groove with the axial frame member;
sliding the at least one roller frame along the roller axle to the locked position; and
engaging the fastener with the at least one panel hold down frame.

27. The clamp assembly of claim 21, wherein the at least one clamp support member is operatively coupled to the at least one secondary groove.

28. The clamp assembly of claim 18, wherein the trommel drum comprises an at least one axial frame member, wherein the at least one axial frame member further comprises:
a mounting profile primary groove disposed on a surface of the at least one axial frame member, the mounting profile including a pair of end notches and a center notch, wherein each clamp support member mounts within one end notch.

29. The clamp assembly of claim 28, wherein the roller clamp structure further comprises a roller engagement face including a pair of roller engagement recesses and a pair of roller engagement members, and wherein the clamp support member further comprises a support engagement face including a pair of support engagement recesses and a support engagement member.

30. The clamp assembly of claim 29, wherein the roller clamp structure is configured to slide along the roller axle to the unlocked position by sliding the roller clamp structure along the roller axle wherein the roller engagement face is disengaged from the support engagement face.

31. The clamp assembly of claim 29, wherein the at least one roller clamp structure is configured to slide along the roller axle to the locked position by sliding the roller clamp structure along the roller axle wherein the roller engagement face engages the support engagement face.

32. The clamp assembly of claim 31, wherein the at least one roller clamp structure further comprises a fastener configured to secure the at least one panel hold down frame and the at least one filter panel.

33. The clamp assembly of claim 32, wherein the fastener is configured to secure the at least one panel hold down frame and the at least one filter panel by
rotating the at least one roller clamp structure at the unlocked position;
sliding the at least one roller clamp structure along the roller axle to the locked position; and
engaging the fastener with the at least one panel hold down frame.

34. The clamp assembly of claim 33, wherein an engagement head of the fastener is countersunk below an upper surface on the roller clamp structure.
